(19) United States
(12) Patent Application Publication
(10) Pub. No.: US 2005/0233935 A1
(43) Pub. Date: Oct. 20, 2005

(54) Structured surfactant compositions

(76) Inventors: Euen Gunn, Trenton, NJ (US); Seren Frantz, Bensalem, PA (US)

Correspondence Address: KEVIN E. MC VEIGH;RHODIA INC., 259 PROSPECT PLAINS ROAD, CRANBURY, NJ, 08512, US

(21) Appl. No.: 11/107,609

(22) Filed: Apr. 15, 2005

Related U.S. Application Data
(60) Provisional application No. 60/562,891, filed on Apr. 15, 2004.

(51) Int. Cl. C11D 17/00

(52) U.S. Cl. 510/418

(57) ABSTRACT

An optically clear aqueous structured surfactant composition that includes from 0 parts by weight to less than 2.5 parts by weight sugar per 100 parts by weight of the composition, and from greater than 7.7 parts by weight to about 50 parts by weight of an anionic surfactant per 100 parts by weight of the composition, and wherein at least a portion of the anionic surfactant is in the form of spherulites, is useful as a ingredient in personal care compositions.

### FIELD OF THE INVENTION

This invention relates to structured surfactant compositions, more particularly to optically clear structured surfactant compositions.

### BACKGROUND OF THE INVENTION

Structured surfactant compositions are typically pumpable, non-Newtonian compositions which have the capacity physically to suspend solid particles by virtue of the presence of a surfactant phase, which may be interspersed with a solvent phase. Typically, the surfactant phase is present as packed spherulites, i.e., lamellar droplets, dispersed in the aqueous phase.

Structured surfactant compositions are useful in such home care applications as liquid detergents, laundry detergents, hard surface cleansers, dish wash liquids, and personal care formulations such as shampoos, body wash, hand soap, lotions, creams, conditioners, shaving products, facial washes, baby care formulations, skin treatments. Other applications may include oil field and agrochemical formulations.

Structured surfactant compositions typically exhibit a cloudy, turbid appearance, which renders them unattractive for applications in which a clear, transparent appearance is desired. International Publication Number WO 00/36079 discloses structured liquid detergent compositions that are said to be substantially clear at 25° C., wherein cloudiness has been addressed by adjusting the refractive index of the solvent phase through the addition of sugars and subjecting the structured surfactant composition to high shear, but states (at page 58, lines 6-8) that shearing in the absence of sugar addition is not sufficient to generate transparency.

### SUMMARY OF THE INVENTION

In a first aspect, the present invention is directed to an optically clear aqueous structured surfactant composition, comprising from 0 parts by weight (pbw) to less than 2.5 pbw sugar per 100 pbw of the composition and from greater than 7.7 pbw to about 50 pbw of an anionic surfactant per 100 pbw of the composition, wherein at least a portion of the anionic surfactant is in the form of spherulites.

In a second aspect, the present invention is directed to a method for making an optically clear aqueous structured surfactant composition, comprising:
providing an aqueous structured surfactant composition comprising, from 0 pbw to less than 2.5 pbw sugar per 100 pbw of the composition and from greater than 7.7 pbw to about 50 pbw of an anionic surfactant per 100 pbw of the composition, wherein at least a portion of the anionic surfactant is in the form of spherulites, and
subjecting the aqueous structured surfactant composition high shear mixing.

In a third aspect, the present invention is directed to a method for improving the optical clarity of an aqueous structured surfactant composition, comprising subjecting the aqueous structured surfactant composition to high shear mixing, wherein the aqueous structured surfactant composition comprises from 0 pbw to less than 2.5 pbw sugar per 100 pbw of the composition and from greater than 7.7 pbw to about 50 pbw of an anionic surfactant per 100 pbw of the composition and wherein at least a portion of the anionic surfactant is in the form of spherulites.

In a fourth embodiment, the present invention is directed to a personal care composition, comprising an optically clear structured surfactant component, said an optically clear structured surfactant component comprising from 0 pbw to less than 2.5 pbw sugar per 100 pbw of the composition and from greater than 7.7 pbw to about 50 pbw of an anionic surfactant per 100 pbw of the composition, wherein at least a portion of the anionic surfactant is in the form of spherulites.

In a fifth aspect, the present invention is directed to a personal care composition, comprising:
an optically clear aqueous structured surfactant composition, said structured surfactant composition comprising from 0 pbw to less than 2.5 pbw sugar per 100 pbw of the composition and from greater than 7.7 pbw to about 50 pbw of an anionic surfactant per 100 pbw of the composition, wherein at least a portion of the anionic surfactant is in the form of spherulites, and
one or more discontinuous phases, each comprising a functional or decorative material, dispersed in the structured surfactant composition.

### DETAILED DESCRIPTION OF INVENTION AND PREFERRED EMBODIMENTS

As used herein, the terminology “optically clear” in reference to a structured surfactant composition means that the composition exhibits an optical transmittance of greater than or equal to 5%, preferably greater than or equal to 10%, more preferably greater than or equal to 25%, and still more preferably greater than or equal to 30%, when measured at a wavelength of 500-570 nanometers through a 1 centimeter path length at 250, using water as the 100% transmittance standard.

The structured surfactant composition of the present invention typically comprises two or more discrete phases. In one embodiment, the composition comprises an aqueous phase and a structured surfactant phase. In one embodiment, the aqueous phase is a continuous phase and the structured surfactant phase is a discontinuous phase and is dispersed in the aqueous phase.

“Lamellar surfactant phases” are phases which comprise a plurality of bilayers of surfactant arranged in parallel and separated by liquid medium. Lamellar phases include both spherulitic phases and the typical form of the liquid crystal G-phase, as well as mixtures thereof. “G-phases”, which are sometimes referred to in the literature as “L, phases”, are typically pourable, non-Newtonian, anisotropic products that are cloudy looking and exhibit a characteristic “smeary” appearance on flowing. Lamellar phases, can exist in several different forms, including domains of parallel sheets which constitute the bulk of the typical G-phases described above and spherulites formed from a number of concentric spherical shells, each of which is a bilayer of surfactant. In this specification the term “G-phase” will be reserved for compositions which are at least partly of the former type. The spherulites are typically between 0.1 and 50 microns in diameter and so differ fundamentally from micelles. Unlike micellar solutions, spherulitic compositions are essentially heterogeneous compositions comprising at least two phases and are typically anisotropic and non-Newtonian. When close packed and stable, spherulites have good solid suspending properties and allow incorporation of insoluble or partially soluble solids, liquids and/or gases as a separate, discontinuous phase suspended in a “spherulitic surfactant phase”, that, is a continuous matrix of the spherulitic composition.

The surfactant phase morphology of the structured surfactant composition is observed, for example, using an optical microscope under cross-polarized light at about 40× magnification.

The spherulitic portion of the anionic surfactant of the structured surfactant composition of the present invention may, and typically does, comprise spherulites of different sizes. Typically, the spherulites of the spherulitic portion of the anionic surfactant are substantially uniformly dispersed in the structured surfactant phase of the composition. More typically, a major portion of the structured surfactant phase comprises such spherulites. Even more typically, the structured surfactant phase comprises a spherulitic surfactant phase and, optionally, one or more lamellar G-phases. Still more typically, the structured surfactant phase is a spherulitic surfactant phase.

In one embodiment, the composition of the present invention exhibits shear-thinning viscosity.

As used herein in reference to viscosity, the terminology “shear-thinning” means that such viscosity decreases with an increase in shear rate. Shear-thinning may be characterized as a “non-Newtonian” behavior, in that it differs from that of a classical Newtonian fluid, for example, water, in which viscosity is not dependent on shear rate.

In one embodiment, the composition of the present invention is capable of suspending water insoluble or partially water soluble components.

As used herein in reference to a component of an aqueous composition, the terminology “water insoluble or partially water soluble components” means that the component is present in the aqueous composition at a concentration above the solubility limit of the component so that, in the case of a water insoluble component, the component remains substantially non-dissolved in the aqueous composition and, in the case of a partially water soluble component, at least a portion of such component remains undissolved in the aqueous composition.

As used herein, characterization of an aqueous composition as “capable of suspending”, or as being “able of suspend” water insoluble or partially water soluble components means that the composition substantially resists flotation of such components in the composition or sinking of such components in such composition so that such components appear to be neutrally buoyant in such composition and remain at least substantially suspended in such composition under the anticipated processing, storage, and use conditions for such aqueous composition.

In one embodiment, the structured surfactant composition of the present invention comprises from about 10 to about 50 pbw, more typically from about 15 to about 40 pbw, and still more typically from about 20 to about 35 pbw, of an anionic surfactant and from about 50 to about 90 pbw, more typically from about 60 to about 85 pbw, and still more typically from about 65 to about 80 pbw water.

As used herein, the term “sugars” includes monosaccharides, such as glucose and fructose, and disaccharides, such as saccharose, sucrose, lactose, and maltose, as well as mixtures thereof. Added sugars change the refractive index of the aqueous phase, but are not desirable because sugars typically have a detrimental effect on skin feel and lubricity and may undesirably decrease foaming.

In one embodiment, the composition of the present invention comprises from 0 to less than 2.5 pbw sugar per 100 pbw of the composition, more typically, from 0 to less than 2.0 pbw sugar per 100 pbw of the composition, even more typically, from 0 to less than 1.0 pbw sugar per 100 pbw of the composition.

Anionic surfactants are known. Any anionic surfactant that is acceptable for use in the intended end use application is suitable as the anionic surfactant component of the composition of the present invention, including, for example, linear alkylbenzene sulfonates, alpha olefin sulfonates, paraffin sulfonates, alkyl ester sulfonates, alkyl sulfates, alkyl alkoxy sulfates, alkyl sulfonates, alkyl alkoxy carboxylates, alkyl alkoxylated sulfates, monoalkyl phosphates, dialkyl phosphates, sarcosinates, isethionates, and taurates, as well as mixtures thereof. Commonly used anionic surfactants that are suitable as the anionic surfactant component of the composition of the present invention include, for example, ammonium lauryl sulfate, ammonium laureth sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium trideceth sulfate, sodium tridecyl sulfate, ammonium trideceth sulfate, ammonium tridecyl sulfate, sodium cocoyl isethionate, disodium laureth sulfosuccinate, sodium methyl oleoyl taurate, sodium laureth carboxylate, sodium trideceth carboxylate, sodium-monoalkyl phosphates, sodium dialkyl phosphates, sodium lauryl sarcosinate, lauroyl sarcosine, cocoyl sarcosinate, ammonium cocyl sulfate, sodium cocyl sulfate, potassium cocyl sulfate, monoethanolamine cocyl sulfate, sodium tridecyl benzene sulfonate, sodium dodecyl benzene sulfonate, and branched anionic surfactants, such as sodium trideceth sulfate, sodium tridecyl sulfate, ammonium trideceth sulfate, and ammonium tridecyl sulfate.

The cation of any anionic surfactant is typically sodium but may alternatively be potassium, lithium, calcium, magnesium, ammonium, or an alkyl ammonium having up to 6 aliphatic carbon atoms including isopropylammonium, monoethanolammonium, diethanolammonium, and triethanolammonium. Ammonium and ethanolammonium salts are generally more soluble that the sodium salts. Mixtures of the above cations may be used.

In one embodiment, the structured surfactant composition of the present invention further comprises at least an effective amount of one or more structuring agents. Suitable structuring agents include cationic surfactants, fatty alcohols, alkoxylated alcohols, fatty acids, fatty acid esters, alkanolamides, and electrolytes. An effective amount of such structuring agent is one that promotes formation of a lamellar surfactant phase.

Cationic surfactants are known. Any anionic surfactant that is acceptable for use in the intended end use application is suitable as the anionic surfactant component of the composition of the present invention, including, for example, cationic surfactants according to formula (1) below: 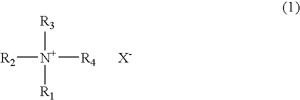
wherein:
R₁, R₂, R₃ and R₄, are independently hydrogen, an organic group, provided that at least one of R₁, R₂, R₃ and R₄ is not hydrogen.
X is an anion.

If one to three of the R groups are hydrogen, the compound may be referred to as an amine salt. Some examples of cationic amines include polyethoxylated (2) oleyl/stearyl amine, ethoxylated tallow amine, cocoalkylamine, oleylamine, and tallow alkyl amine.

For quaternary ammonium compounds (generally referred to as quats) R₁, R₂, R₃, and R₄ may be the same or different organic group, but may not be hydrogen. In one embodiment, R₁, R₂, R₃, and R₄ are each C₈-C₂₄ branched or linear which may comprise additional functionality such as, for example, fatty acids or derivatives thereof, including esters of fatty acids and fatty acids with alkoxylated groups; alkyl amido groups; aromatic rings; heterocyclic rings; phosphate groups; epoxy groups; and hydroxyl groups. The nitrogen atom may also be part of a heterocyclic or aromatic ring system, e.g., cetethyl morpholinium ethosulfate or steapyrium chloride.

Suitable anions include, for example, chloride, bromide, methosulfate, ethosulfate, lactate, saccharinate, acetate or phosphate.

Examples of quaternary ammonium compounds of the monoalkyl amine derivative type include: cetyl trimethyl ammonium bromide (also known as CETAB or cetrimonium bromide), cetyl trimethyl ammonium chloride (also known as cetrimonium chloride), myristyl trimethyl ammonium bromide (also known as myrtrimonium bromide or Quaternium-13), stearyl dimethyl benzyl ammonium chloride (also known as stearalkonium chloride), oleyl dimethyl benzyl ammonium chloride, (also known as olealkonium chloride), lauryl/myristryl trimethyl ammonium methosulfate (also known as cocotrimonium methosulfate), cetyl-dimethyl-(2)hydroxyethyl ammonium dihydrogen phosphate (also known as hydroxyethyl cetyidimonium phosphate), bassuamidopropylkonium chloride, cocotrimonium chloride, distearyldimonium chloride, wheat germ-amidopropalkonium chloride, stearyl octyidimonium methosulfate, isostearaminopropal-konium chloride, dihydroxypropyl PEG-5 linoleaminium chloride, PEG-2 stearmonium chloride, Quaternium 18, Quaternium 80, Quaternium 82, Quaternium 84, behentrimonium chloride, dicetyl dimonium chloride, behentrimonium methosulfate, tallow trimonium chloride and behenamidopropyl ethyl dimonium ethosulfate.

Quaternary ammonium compound of the dialkyl amine derivative type distearyldimonium chloride, dicetyl dimonium chloride, stearyl octyldimonium methosulfate, dihydrogenated palmoylethyl hydroxyethylmonium methosulfate, dipalmitoylethyl hydroxyethylmonium methosulfate, dioleoylethyl hydroxyethylmonium methosulfate, hydroxypropyl bisstearyldimonium chloride, and mixtures thereof.

Quaternary ammonium compounds of the imidazoline derivative type include, for example, isostearyl benzylimidonium chloride, cocoyl benzyl hydroxyethyl imidazolinium chloride, cocoyl hydroxyethylimidazolinium PG-chloride phosphate, Quaternium 32, and stearyl hydroxyethylimidonium chloride, and mixtures thereof.

Suitable fatty alcohols include, for example, (C₁₀-C₂₄) saturated or unsaturated branched or straight chain alcohols, more typically (C₁₀-C₂₀) saturated or unsaturated branched or straight chain alcohols, such as for example, decyl alcohol, lauryl alcohol, myristyl alcohol, cetyl alcohol, stearyl alcohol, oleyl alcohol, linoleyl alcohol and linolenyl alcohol.

Suitable alkoxylated alcohols include alkoxylated, typically ethoxylated, derivatives of (C₁₀-C₂₄) saturated or unsaturated branched or straight chain alcohols, more typically (C₁₀-C₂₀) saturated or unsaturated branched or straight chain alcohols, which may include, on average, from 1 to 22 alkoxyl units per molecule of alkoxylated alcohol, such as, for example, ethoxylated lauryl alcohol having an average of 5 ethylene oxide units per molecule.

Suitable fatty acids include (C₁₀-C₂₄) saturated or unsaturated carboxylic acids, more typically (C₁₀-C₂₂) saturated or unsaturated carboxylic acids, such as, for example, lauric acid, oleic acid, stearic acid, myristic acid, cetearic acid, isostearic acid, linoleic acid, linolenic acid, ricinoleic acid, elaidic acid, arichidonic acid, myristoleic acid, and palmitoleic acid, as well as neutralized versions thereof.

Suitable fatty acid esters include esters of (C₁₀-C₂₄) saturated or unsaturated carboxylic acids, more typically (C₁₀-C₂₂) saturated or unsaturated carboxylic acids, for example, propylene glycol isostearate, propylene glycol oleate, glyceryl isostearate, and glyceryl oleate,.

Suitable alkanolamides include aliphatic acid alkanolamides, such as cocamide MEA (coco monoethanolamide) and cocamide MIPA (coco monoisopropanolamide), as well as alkoxylated alkanolamides.

In one embodiment, the structured surfactant composition of the present invention comprises, based on 100 pbw of the composition, from about 0.1 to about 25 pbw, more typically, from about 0.5 to about 10 pbw, of a structuring agent.

Some surfactants, especially very oil soluble surfactants such as isopropylamine alkyl benzene sulphonates are able to form flocculated, structured compositions in water, even in the absence of electrolyte. In such instances the aqueous medium may consist essentially of water. However, some surfactants only flocculate in the presence of dissolved electrolyte, and in particular in highly concentrated solutions of electrolyte.

Suitable electrolytes include salts of multivalent anions, such as potassium pyrophosphate, potassium tripolyphosphate, and sodium or potassium citrate, salts of multivalent cations, including alkaline earth metal salts such as calcium chloride and calcium bromide, as well as zinc halides, barium chloride and calcium nitrate, salts of monovalent cations with monovalent anions, including alkali metal or ammonium halides, such as potassium chloride, sodium chloride, potassium iodide, sodium bromide, and ammonium bromide, alkali metal or ammonium nitrates, and polyelectrolytes, such as uncapped polyacrylates, polymaleates, or polycarboxylates, lignin sulphonates or naphthalene sulphonate formaldehyde copolymers.

Typically, the greater the amount of surfactant present in relation to its solubility, the smaller the amount electrolyte that may be required in order to form a structure capable of supporting solid materials and/or to cause flocculation of the structured surfactant. In one embodiment, the composition contains a sufficient amount of an electrolyte to promote spherulite formation.

Electrolyte may be added as a separate component or in combination with other components of the composition of the present invention.

In one embodiment, the structured surfactant composition of the present invention comprises, based on 100 pbw of the structured surfactant composition, up to about 40 pbw, more typically from about 1 to about 30 pbw, and still more typically from about 2 to about 20 pbw of an electrolyte.

The composition of the present invention may further comprise in addition to the anionic surfactant and structuring agent, a cationic surfactant, a non-ionic surfactant, an amphoteric surfactant, a zwitterionic surfactant, or a mixture thereof.

Nonionic surfactants are known. Any nonionic surfactant that is acceptable for use in the intended end use application is suitable as the optional nonionic surfactant component of the composition of the present invention, including compounds produced by the condensation of alkylene oxide groups with an organic hydrophobic compound which may be aliphatic or alkyl aromatic in nature. Examples of useful nonionic surfactants include the polyethylene, polypropylene, and polybutylene oxide condensates of alkyl phenols, fatty acid amide surfactants, polyhydroxy fatty acid amide surfactants, amine oxide surfactants, alkyl ethoxylate surfactants, alkanoyl glucose amide surfactants, and alkylpolyglycosides. Specific examples of suitable nonionic surfactants include alkanolamides such as cocamide DEA, cocamide MEA, cocamide MIPA, PEG-5 cocamide MEA, lauramide DEA, and lauramide MEA; alkyl amine oxides such as lauramine oxide, cocamine oxide, cocamidopropylamine oxide, and lauramidopropylamine oxide; sorbitan laurate, sorbitan distearate, fatty acids or fatty acid esters such as lauric acid, isostearic acid, and PEG-150 distearate; fatty alcohols or ethoxylated fatty alcohols such as lauryl alcohol, laureth-4, laureth-7, laureth-9, laureth-40, trideceth alcohol, C11-15 pareth-9, C12-13 Pareth-3, and C14-15 Pareth-11, alkylpolyglucosides such as decyl glucoside, lauryl glucoside, and coco glucoside.

Zwitterionic surfactants are known. Any Zwitterionic surfactant that is acceptable for use in the intended end use application is suitable as the optional Zwitterionic surfactant component of the composition of the present invention, including, for example, those which can be broadly described as derivatives of aliphatic quaternary ammonium, phosphonium, and sulfonium compounds in which the aliphatic radicals can be straight chain or branched and wherein one of the aliphatic substituents contains from about 8 to 18 carbon atoms and one contains an anionic water-solubilizing group such as carboxyl, sulfonate, sulfate, phosphate or phosphonate. Specific examples of suitable Zwitterionic surfactants include alkyl betaines, such as cocodimethyl carboxymethyl betaine, lauryl dimethyl carboxymethyl betaine, lauryl dimethyl alpha-carboxy-ethyl betaine, cetyl dimethyl carboxymethyl betaine, lauryl bis-(2-hydroxy-ethyl)carboxy methyl betaine, stearyl bis-(2-hydroxy-propyl)carboxymethyl betaine, oleyl dimethyl gamma-carboxypropyl betaine, and lauryl bis-(2-hydroxypropyl)alpha-carboxyethyl betaine, amidopropyl betaines, and alkyl sultaines, such as cocodimethyl sulfopropyl betaine, stearyidimethyl sulfopropyl betaine, lauryl dimethyl sulfoethyl betaine, lauryl bis-(2-hydroxy-ethyl)sulfopropyl betaine, and alkylamidopropylhydroxy sultaines.

Amphoteric surfactants are known. Any amphoteric surfactant that is acceptable for use in the intended end use application is suitable as the optional amphoteric surfactant component of the composition of the present invention, including, for example, derivatives of aliphatic secondary and tertiary amines in which the aliphatic radical can be straight chain or branched and wherein one of the aliphatic substituents contains from about 8 to about 18 carbon atoms and one contains an anionic water solubilizing group. Specific examples of suitable amphoteric surfactants include the alkali metal, alkaline earth metal, ammonium or substituted ammonium salts of alkyl amphocarboxy glycinates and alkyl amphocarboxypropionates, alkyl amphodipropionates, alkyl amphodiacetates, alkyl amphoglycinates, and alkyl amphopropionates, as well as alkyl iminopropionates, alkyl iminodipropionates, and alkyl amphopropylsulfonates, such as for example, cocoamphoacetate cocoamphopropionate, cocoamphodiacetate, lauroamphoacetate, lauroamphodiacetate, lauroamphodipropionate, lauroamphodiacetate, cocoamphopropyl sulfonate caproamphodiacetate, caproamphoacetate, caproamphodipropionate, and stearoamphoacetate.

In one embodiment, the surfactant component of the present invention may optionally comprise, based on 100 pbw of the total amount of surfactants:
up to about 20 pbw, more typically from about 1 to about 10, and still more typically from about 2 to about 6, of an cationic surfactant,
up to about 20 pbw, more typically from about 0.75 to 10, and still more typically from about 1 to about 5 of an nonionic surfactant,
up to about 25 pbw, more typically from about 1 to about 20, and still more typically from about 2 to about 10 of an Zwitterionic or amphoteric surfactant.

The structured surfactant composition of the present invention may optionally further comprise one or more preservatives, such as benzyl alcohol, methyl paraben, propyl paraben, or imidazolidinyl urea, and DMDM hydantoin, and may optionally further comprise one or more pH adjusting agents, such as citric acid, succinic acid, phosphoric acid, sodium hydroxide, or sodium carbonate.

In general, the structured surfactant composition is made by combining and mixing the anionic surfactant and water and optionally, adjusting the pH and/or adding a preservative and then adding the structuring agent and then subjecting the composition to high shear mixing. As used herein, the term “high shear mixing” refers to mixing under high shear conditions, typically at a shear rate of greater than or equal to about 1,000 s⁻¹, more typically greater than or equal to about 3,500 s⁻¹

The structured surfactant may be subjected to a high shear mixing in known mixing equipment, such as, for example, a high shear mixer or a homogenizer.

Shear-thinning viscosity is measured by known viscometric methods, such as for example, using a rotational viscometer, such as a Brookfield viscometer. In one embodiment, the composition of the present invention exhibits shear-thinning behavior when subjected to viscosity measurement using a Brookfield rotational viscometer, equipped with an appropriate spindle, at a rotation speed of from about 0.1 revolutions per minute (“rpm”) to about 60 rpm.

The composition of the present invention is capable of suspending water-insoluble particles or partially water soluble components, such as vegetable oils, mineral oils, silicone oils, solid particles, abrasives, and similar articles. The composition provides a means to include otherwise difficult to incorporate components in surfactant mixtures resulting in cosmetic preparations with multi-functional benefits including, in some cases, cleansing, moisturizing, improved skin feel, exfoliation/abrasion, novel appearance, or a combination of these benefits.

The ability of a composition to suspend water insoluble or partially water soluble components is typically evaluated by mixing the composition with sufficient vigor to entrap air bubbles in the composition and then visually observing whether the air bubbles remain entrapped in the composition for a defined period of time, such as for example, 12 to 24 hours, under defined environmental conditions, such as for example, room temperature. In one embodiment, the composition of the present invention is capable of suspending air bubbles for at least 1 week, and more typically for at least 3 months. A composition that is capable of suspending air bubbles under the for at least 12 hours at room temperature is deemed to be generally capable of suspending water insoluble or partially water soluble components in the composition under generally anticipated processing, storage, and use conditions for such composition. For components other than air, the result of the air suspension test should be confirmed by conducting an analogous suspension test using the component of interest. For unusually rigorous processing, storage and/or use conditions, more rigorous testing may be appropriate.

In one embodiment, the ability to suspend water insoluble or partially water soluble components is evaluated under more rigorous conditions, that is, the mixed samples are visually evaluated after subjecting the samples to one or more freeze/thaw cycles, wherein each freeze/thaw cycle consists of 12 hours at −10° C. and 12 hours at 25° C. In one embodiment, composition of the present invention remains capable of suspending air bubbles after one freeze/thaw cycle, more typically after 3 freeze/thaw cycles.

The composition of the present invention is useful in, for example, personal care applications, such as shampoos, body wash, hand soap, lotions, creams, conditioners, shaving products, facial washes, neutralizing shampoos, personal wipes, and skin treatments, and in home care applications, such as liquid detergents, laundry detergents, hard surface cleansers, dish wash liquids, toilet bowl cleaners, as well as other applications, such as oil field and agrochemical applications.

In one embodiment, the personal care composition of the present invention comprises one or more materials that are not soluble or are only partly soluble in the structured surfactant system, and may be in the form of a solid, liquid, or gas and may provide be benefit agents such as, for example, emollients, moisturizers, conditioners vitamins, abrasives, UV absorbers, antimicrobial agents, and/or appearance modifying additives, such as, for example, colored particles or reflective particles.

The personal care composition according to the present invention may optionally further comprise other ingredients, such as, for example, preservatives such as benzyl alcohol, methyl paraben, propyl paraben and imidazolidinyl urea; thickeners and viscosity modifiers such as block polymers of ethylene oxide and propylene oxide, polyethylene glycol distearates, polyglyceryl diisostearate, clays, substituted or unsubstituted hydrocolloids, acrylates, acrylates/C10-30 alkyl acrylates crosspolymers. Some examples of clays include bentonite, kaolin, montmorillonite, sodium magnesium silicate, hectorite, magnesium aluminum silicate (Veegum). Some examples hydrocolloids in the unmodified form include Agar, Alginate, Arabinoxylan, Carrageenan, Cellulose such as Carboxyalkyl Celluose, Hydroxyalkyl Cellulose, Hydroxyalkyl Alkyl Cellulose, Alkyl Cellulose, Curdlan, Gelatin, Gellan, B-Glucan, Guar gum, Gum arabic, Locust bean gum, Pectin, Starch, Succinoglycan (Rheozan from Rhodia), Xanthan gum. Some examples of modified or substituted hydrocolloids are hydroxy methyl cellulose, PG-hydroxyethyl cellulose, quaternary ammoniums of hydroxyethylcellulose, quaternairy ammoniums of guar gum (Jaguar C-17, Jaguar C-14S, Jaguar Excel, Jaguar C-162 from Rhodia), hydroxypropyl guars (Jaguar HP-8, Jaguar HP-105, Jaguar HP-60, Jaguar HP-120, Jaguar C-162), modified starches such as sodium hydroxypropyl starch phosphate (Pure-Gel 980 and Pure-Gel 998 from Grain Processing Corporation), potato starch modified (Structure-Solanace from National Starch), acrylates copolymers such as Acrylates/Aminoacrylates/C10-30 Alkyl PEG-20 Itaconate Copolymer (Structure-Plus from National Starch), cationic polymers (Rheovis CSP, Rheovis CDE, Rheovis CDP from Ciba), Polyacrylimidomethylpropane Sulfonate/Polyquaternium4 (Plexagel ASC from ISP), hydrohobically modified nonionic polyols (Acusol 880, Acusol 882 from Rhom & Haas), and PEG-150 Distearate, electrolytes, such as sodium chloride, sodium sulfate, polyvinyl alcohol, and sodium citrate; pH adjusting agents such as citric acid, succinic acid, phosphoric acid, sodium hydroxide, sodium carbonate; perfumes; dyes; conditioning agents such as organosilicon materials, including, silicone gums, polyorganosiloxane fluids, and silicone resins, i.e., crosslinked polyorganosiloxane systems; active ingredients such as anti-dandruff agents (zinc pyrithion); vitamins or their derivatives such as Vitamin B, Vitamin E Acetate; and sequestering agents such as disodium ethylenediamine tetra-acetate. In general, personal care compositions may optionally comprise, based on 100 pbw of the personal care composition and independently for each such ingredient, up to about 10 pbw, preferably from 0.5 pbw to about 5.0 pbw, of such other ingredients, depending on the desired properties of the personal care composition.

In one embodiment, the personal care composition of the present invention comprises an optically clear aqueous structured surfactant component according to the present invention that forms a first “phase” (which may itself comprise a plurality of phases, including aqueous phases, laminar surfactant phases and spherulitic surfactant phases, as discussed above) and the composition further comprises one or more additional phases that are at least substantially distinct from such first phase. As used herein in reference to the phases of a multiphase embodiments of the present invention, the terminology “substantially distinct” means that the phases each exhibit substantially homogeneous properties within a given phase and that the phases differ with respect to at least one characteristic or property, such as for example, visual characteristics, such as color, clarity, pearlescence, or physical/chemical properties, such as viscosity, lubricity, and/or benefit agent content.

In one embodiment, the optically clear aqueous structured surfactant component forms a first phase that exhibits shear-thinning viscosity and/or is capable of suspending water insoluble or partially water soluble components.

In one embodiment, the optically clear aqueous structured surfactant component forms a first phase, typically a continuous phase, that exhibits shear-thinning viscosity and is capable of suspending water insoluble or partially water soluble components and the composition further comprises at least one additional phase, typically a discontinuous phase, that is at least substantially distinct form the first phase, wherein the additional phase comprises one or more water insoluble or partially water soluble components.

In one embodiment, the optically clear aqueous structured surfactant component forms a first phase that exhibits shear-thinning viscosity and is capable of suspending water insoluble or partially water soluble components and the composition further comprises at least one additional aqueous phase, such as a second structured surfactant component, that is at least substantially distinct from the first phase and that exhibits shear-thinning viscosity and is capable of suspending water insoluble or partially water soluble components.

In one embodiment, the optically clear aqueous structured surfactant component forms a first phase and the composition further comprises at least one additional phase that is at least substantially distinct from the first phase wherein each of such phases is a continuous phase and the phases are disposed adjacent to each other.

In one embodiment, the optically clear aqueous structured surfactant component forms a first phase and the composition further comprises at least one additional phase that is at least substantially distinct from the first phase wherein one of such phases is a continuous phase, the other of such phases is a discontinuous phase, and the discontinuous phase is dispersed within the continuous phase.

In one embodiment, the optically clear structured surfactant component forms a first phase and the composition further comprises at least one additional phase wherein that is at least substantially visually distinct from the first phase, such as for example, a composition comprising an opaque water insoluble component suspended in an optically clear aqueous structured surfactant component.

### EXAMPLE 1

The composition of Example 1 was made by mixing the relative amounts of the ingredients listed in TABLE I, shearing the mixture using a Ross Model No. ME100L mixer at speed 8-10 (with small holes in the screen) for approximately 5 minutes and centrifuging a 50 mL sample of the sheared mixture at 6,000 RPM for 15 minutes. The composition of Example 1 showed a very slight haze, but was significantly clearer than an analogous non-sheared sample.

TABLE I

| | Amount |
|---|---|
| Ingredient | (pbw per 100 pbw of composition) |
| 30% Aqueous solution of sodium | 52.2 |
| trideceth sulfate | |
| Cetrimonium bromide | 4.8 |
| 32% Aqueous solution of lauryl | 16.2 |
| amphoacetate | |
| 50% Aqueous solution of citric acid | 1.8 |
| Preservative (Glydant) | 0.1 |
| Water | 24.9 |

The composition of Example 2 was made by applying additional shear to sheared, but non-centrifuged, mixture of ingredients from Example 1 using an Ultra Turrax, T25 basic IKA Larortechnik homogenizer at speed 6 (24,000 1/min) for approximately 2 minutes and then centrifuging the sheared composition under the same conditions as used for the composition of Example 1. The composition of Example 2 exhibited improved clarity compared to the composition of Example 1.

### EXAMPLES 3-6

A stock composition for use in making the compositions of Examples 3-6 was made by mixing the relative amounts of the ingredients listed in TABLE 1 above.

The compositions of Examples 3-6 were each made by shearing a 300 g sample of the stock composition in a 600 mL beaker using an IKA Labortechnic Eurostar Power D mixer with a 2 inch diameter four-bladed disk turbine at the respective speeds indicated in TABLE II below and then centrifuging the sample for 30 minutes at 4500 rpm.

The % transmittance of each of the compositions of Examples 3-6 was then measured with a Varian Model CARY100 UV/VIS spectrophotometer using water as the standard for 100% transmittance. The % transmittance for each composition is set forth below in TABLE II after mixing for various times. A viscosity profile for each composition, as measured following high shear mixing using a Brookfield RVT Viscometer, equipped with a T-bar E, for 1 minute at 25 deg C. is also set forth in Table II.

TABLE II

| | Mixing | Mixing | Viscosity | |
|---|---|---|---|---|
| | Speed | Time | (cp, at | % |
| Ex. No. | (rpm) | (min) | 2.5 rpm/10 rpm/50 rpm) | Transmittance |
| 3 | 1000 | 3 | | 10.5 |
| | | 8 | | 10.5 |
| | | 23 | | 13.7 |
| | | 53 | | 19.1 |
| | | 135 | 204,000/62,500/15,100 | 33 |
| 4 | 1500 | 4 | | 15 |
| | | 10 | | 18.3 |
| | | 20 | | 16 |
| | | 45 | | 20.5 |
| | | 75 | | 25.7 |
| | | 100 | 126,000/3,900/9,300 | 27 |
| 5 | 2000 | 2 | | 14.3 |
| | | 7 | | 17.4 |
| | | 15 | | 18.6 |
| | | 30 | | 20 |
| | | 70 | 170,000/52,500/11,600 | 27 |
| 6 | 1000 at | 20 | | 11.5 |
| | 50° C. | | | |
| | | 50 | | 12.6 |
| | | 90 | | 14.3 |
| | | 135 | | 14.3 |
| | | 180 | 126,000/41,000/9,800 | 14.3 |

1. An optically clear aqueous structured surfactant composition, comprising: from 0 parts by weight to less than 2.5 parts by weight sugar per 100 parts by weight of the composition and from greater than 7.7 parts by weight to about 50 parts by weight of an anionic surfactant per 100 parts by weight of the composition, wherein at least a portion of the anionic surfactant is in the form of spherulites.

2. The composition of claim 1, wherein the composition exhibits shear-thinning viscosity.

3. The composition of claim 1, wherein the composition is capable of suspending water insoluble or partially water soluble components.

4. The composition of claim 1, wherein the anionic surfactant is selected from linear alkylbenzene sulfonates, alpha olefin sulfonates, paraffin sulfonates, alkyl ester sulfonates, alkyl sulfates, alkyl alkoxy sulfates, alkyl sulfonates, alkyl alkoxy carboxylates, alkyl alkoxylated sulfates, monoalkyl phosphates, dialkyl phosphates, sarcosinates, isethionates, taurates, and mixtures thereof.

5. The composition of claim 1, wherein the composition further comprises at least an effective amount of one or more structuring agents.

6. The composition of claim 5, wherein the structuring agent is selected from cationic surfactants, fatty alcohols, alkoxylated alcohols, fatty acids, fatty acid esters, alkanolamides, electrolytes, and mixtures thereof.

7. The composition of claim 6, wherein the composition further comprises one or more cationic surfactants according to formula (1) below: 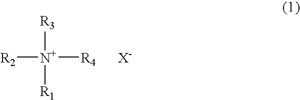
wherein:
R₁, R₂, R₃ and R₄, are independently hydrogen, an organic group, provided that at least one of R₁, R₂, R₃ and R₄ is not hydrogen.
X is an anion.

8. The composition of claim 7, wherein the cationic surfactant comprises a quaternary ammonium compound.

9. The composition of claim 6, wherein the composition further comprises one or more alkanolamides selected from aliphatic acid alkanolamides, alkoxylated alkanolamides.

10. A method for making an optically clear structured surfactant composition, comprising:
making an aqueous structured surfactant composition comprising from 0 parts by weight to less than 2.5 parts by weight sugar per 100 parts by weight of the composition and from greater than 7.7 parts by weight to about 50 parts by weight of an anionic surfactant per 100 parts by weight of the composition, wherein at least a portion of the anionic surfactant is in the form of spherulites, and
subjecting the structured surfactant composition to high shear mixing.

11. The method of claim 10, wherein the structured surfactant composition is subjected to high shear mixing at shear rate of greater than or equal to about 1,000 s⁻¹.

12. A method for improving the optical clarity of an aqueous structured surfactant composition, comprising subjecting an aqueous structured surfactant composition to high shear mixing, wherein said aqueous structured surfactant composition comprises from 0 parts by weight to less than 2.5 parts by weight sugar per 100 parts by weight of the composition, from greater than 7.7 parts by weight to about 50 parts by weight of an anionic surfactant per 100 parts by weight of the composition, wherein at least a portion of the anionic surfactant is in the form of spherulites.

13. A personal care composition, comprising an optically clear structured surfactant component, said an optically clear structured surfactant component comprising from 0 pbw to less than 2.5 pbw sugar per 100 pbw of the composition and from greater than 7.7 pbw to about 50 pbw of an anionic surfactant per 100 pbw of the composition wherein at least a portion of the anionic surfactant is in the form of spherulites.

14. The composition of claim 13, wherein the optically clear structured surfactant component exhibits shear-thinning viscosity or is capable of suspending water insoluble or partially water soluble components or exhibits shear-thinning viscosity and is capable of suspending water insoluble or partially water soluble components.

15. The composition of claim 13, wherein the composition further comprises one or more benefit agents.

16. The composition of claim 13, wherein the optically clear structured surfactant component forms a first phase and the composition further comprises one or more additional phases that are at least substantially distinct from the first phase.

17. The composition of claim 13, wherein the optically clear aqueous structured surfactant component forms a first phase that exhibits shear-thinning viscosity and is capable of suspending water insoluble or partially water soluble components and the composition further comprises at least one additional phase that is at least substantially distinct from the first phase, wherein the additional phase comprises one or more water insoluble or partially water soluble components.

18. The composition of claim 13, wherein the first phase is a continuous phase, the additional phase is a discontinuous phase and the discontinuous phase is dispersed in the continuous phase.

19. The composition of claim 13, wherein the optically clear aqueous structured surfactant component forms a first phase and the composition further comprises at least one additional phase wherein that is at least substantially visually distinct from the first phase

20. A personal care composition, comprising:
an optically clear aqueous structured surfactant composition, said structured surfactant composition comprising from 0 parts by weight to less than 2.5 parts by weight sugar per 100 parts by weight of the composition, and from greater than 7.7 parts by weight to about 50 parts by weight of an anionic surfactant per 100 parts by weight of the composition, wherein at least a portion of the anionic surfactant is in the form of spherulites and
one or more discontinuous phases, each comprising a functional or decorative material, dispersed in the structured surfactant composition.

21. The composition of claim 20, wherein the optically clear aqueous structured surfactant composition forms a continuous phase.

22. The composition of claim 20, wherein the one or more discontinuous phases each comprise a water insoluble or partially water soluble component.

23. The composition of claim 22, wherein the water insoluble or partially water soluble component is selected from emollients, moisturizers, conditioners vitamins, abrasives, UV absorbers, antimicrobial agents, appearance modifying additives, and mixtures thereof.
